(19) United States
(12) Patent Application Publication
(10) Pub. No.: US 2004/0108958 A1
(43) Pub. Date: Jun. 10, 2004

(54) Wide-band antenna

(76) Inventor: Huei-Hsin Sun, Taipei City (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/314,503

(22) Filed: Dec. 9, 2002

(51) Int. Cl. H01Q 1/24; H01Q 1/52

(52) U.S. Cl. 343/702; 343/700 MS

(57) ABSTRACT

A wide-band antenna assembly is mounted on a circuit board including a contact and a radio frequency module electrically connected to the contact. The assembly comprises a plane antenna formed of a thin film based magnetic material, and a cover formed of plastic or metal material having shielding capability The cover is releasably secured to the circuit board and includes a rectangular recess with the plane antenna formed therein and a slit on the recess for permitting a bent end of the plane antenna to pass through to be electrically connected to the contact. The assembly can substantially eliminate adverse effect caused by electrical/electronic components of the circuit board, resulting in a great improvement of communication quality.

### FIELD OF THE INVENTION

The present invention relates to antennas and more particularly to a wide-band antenna with improved characteristics.

### BACKGROUND OF THE INVENTION

Recently, there are antennas (e.g., wide-band antennas) mounted in computers (e.g., notebook computers) or PDAs (personal digital assistants). A conventional wide-band antenna assembly (e.g., plane antenna) 10 is shown in FIG. 1. The plane antenna 10 comprises a seat 101 having a circuitry embedded therein. The seat 101 is in turn mounted on a circuit board 30. The circuitry of the plane antenna 10 is electrically connected to a radio frequency module 301 through a contact 302 both on the circuit board 30.

However, the prior art suffered from several disadvantages. For example, communication quality of the plane antenna 10 is poor because it is in contact with the circuit board 30 (i.e., significantly, adversely affected by electrical/electronic components of the circuit board 30). A solution to this problem is to increase height of the seat 101. However, it can consume precious space and increase manufacturing cost. Moreover, the plane antenna 10 is enclosed by threadedly securing a cover 20 to the circuit board 30. In addition, the cover 20 is prohibited from being made of a metal material having shielding effect. This further limits the applications of such antenna. Thus improvement exists.

### SUMMARY OF THE INVENTION

It is therefore an object of the present invention to provide a wide-band antenna device mounted on a circuit board including a contact and a radio frequency module electrically connected to the contact, comprising a plane antenna formed of a thin film based magnetic material; and a cover formed of plastic or metal material having shielding capability. The cover is releasably secured to the circuit board and includes a rectangular recess with the plane antenna formed therein and a slit adjacent one side of the recess for permitting a bent end of the plane antenna to pass through to be electrically connected to the contact. By utilizing the wide-band antenna device, electrical/electronic components of the circuit board will cause little adverse effect, resulting in, a great improvement of communication quality.

In one aspect of the present invention, the cover is formed of plastic or metal material having shielding capability.

In another aspect of the present invention, the plane antenna is formed on the recess by printing in response to a surface processing performed on the cover so as to maintain insulation between the plane antenna and the cover.

In still another aspect of the present invention, further comprises a protective layer formed of a non-shielding material coated on the plane antenna.

The above and other objects, features and advantages of the present invention will become apparent from the following detailed description taken with the accompanying drawings.

### BRIEF DESCRIPTION OF THE DRAWINGS

FIG. 1 is an exploded view of a conventional wide-band antenna assembly mounted on a circuit board;

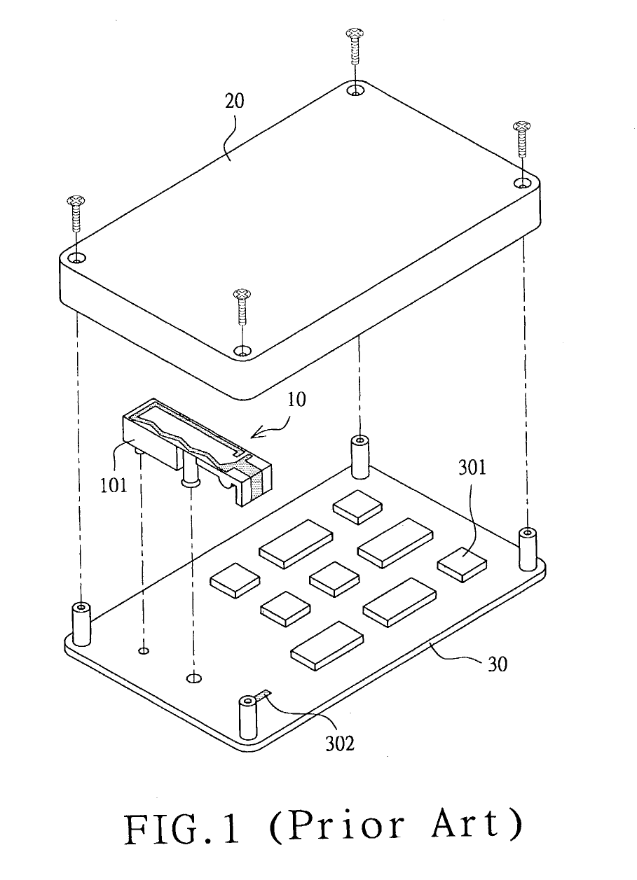

FIG. 2 is an exploded view of a first preferred embodiment of a wide-band antenna assembly according to the invention mounted on a circuit board;

FIG. 3 is a top plan view of FIG. 2; and

FIG. 4 is an exploded view of a second preferred embodiment of a wide-band antenna assembly according to the invention mounted on a circuit board.

### DETAILED DESCRIPTION OF THE PREFERRED EMBODIMENTS

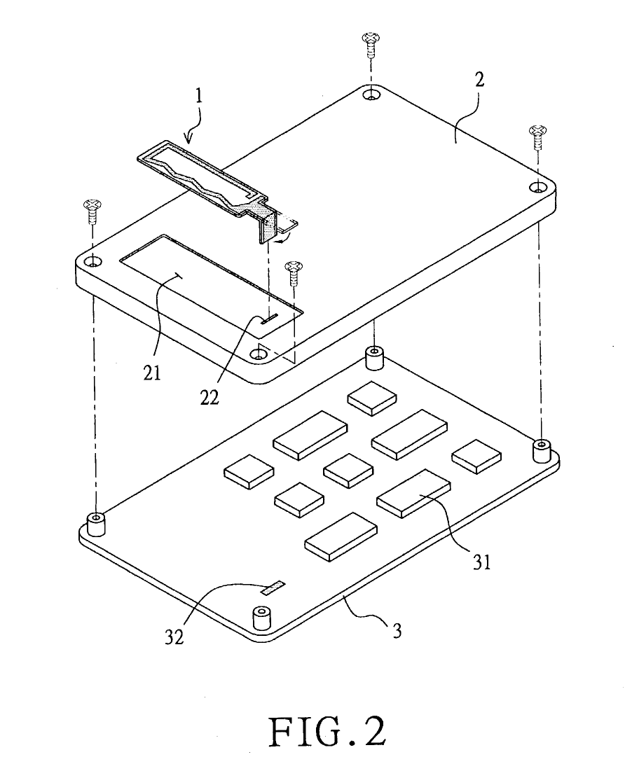

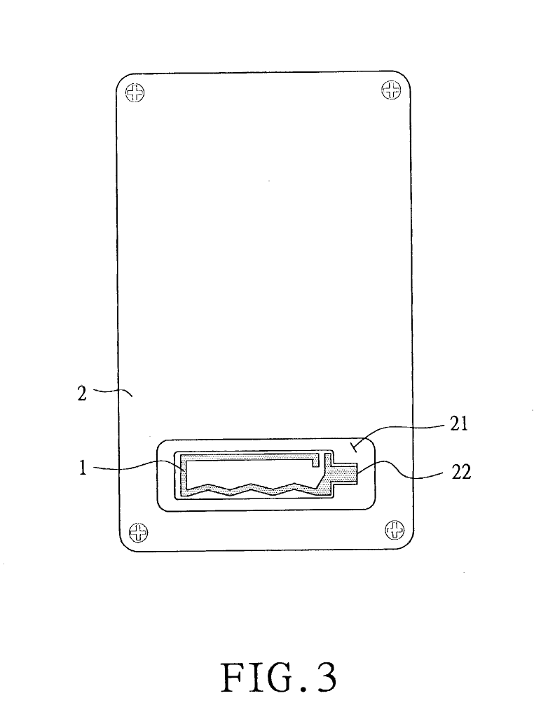

Referring to FIGS. 2 and 3, there is shown a first preferred embodiment of a wide-band antenna assembly constructed in accordance with the invention. The wide-band antenna assembly comprises a plane antenna 1 formed of a thin film based magnetic material and a cover 2 formed of plastic or metal material having shielding effect. The cover 2 is threadedly secured to a circuit board 30 and includes a rectangular recess 21 with the plane antenna 1 glued or adhered otherwise therein and a slit 22 adjacent one side of the recess 21 for permitting a bent end of the plane antenna 1 to pass through to be electrically connected to a contact 32 of the circuit board 30. The contact 32 is in turn electrically connected to a radio frequency module 31 of the circuit board 30. Note that a protective layer formed of non-shielding material may be coated on the plane antenna 1.

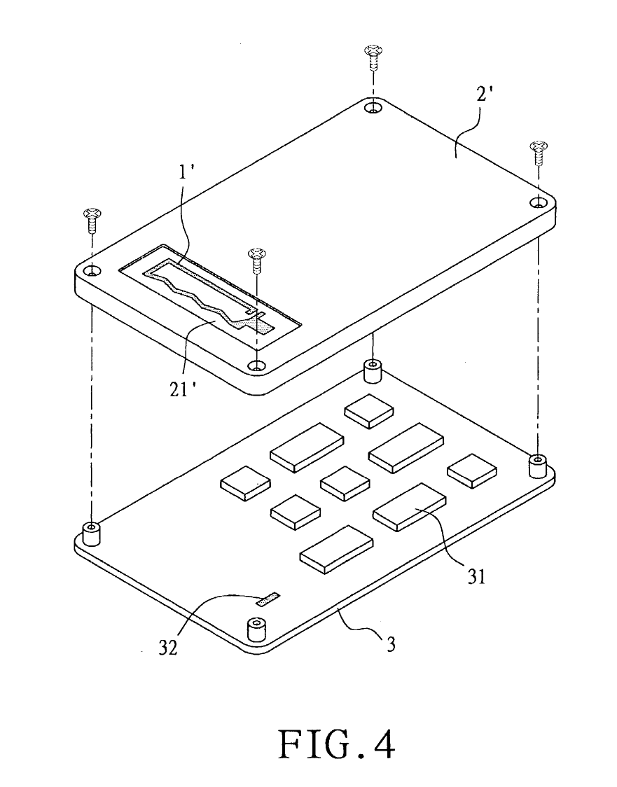

Referring to FIG. 4, there is shown a second preferred embodiment of a wide-band antenna assembly in accordance with the invention. The characteristics of the second preferred embodiment are detailed below. A surface processing is performed on a cover 2′. Next, it is possible of directly forming a plane antenna 1′ on a recess 21′ of the cover 2′ by printing in which an insulation layer (not shown) is formed between the plane antenna 1′ and the cover 2′.

While the invention has been described by means of specific embodiments, numerous modifications and variations could be made thereto by those skilled in the art without departing from the scope and spirit of the invention set forth in the claims.

What is claimed is:

1. A wide-band antenna device mounted on a circuit board including a contact and a radio frequency module electrically connected to the contact, comprising:
a plane antenna formed of a thin film based magnetic material; and
a cover releasably secured to the circuit board and including a rectangular recess with the plane antenna formed therein and a slit adjacent one side of the recess for permitting a bent end of the plane antenna to pass through to be electrically connected to the contact.

2. The wide-band antenna device of claim 1, wherein the cover is formed of plastic or metal material having shielding capability.

3. The wide-band antenna device of claim 1, wherein the plane antenna is formed on the recess by printing in response to a surface processing performed on the cover so as to maintain insulation between the plane antenna and the cover.

4. The wide-band antenna device of claim 1, further comprising a protective layer formed of a non-shielding material coated on the plane antenna.
